(19) United States
(12) Patent Application Publication
(10) Pub. No.: US 2021/0293421 A1
(43) Pub. Date: Sep. 23, 2021

(54) METHOD AND ARRANGEMENT IN CONNECTION WITH A BUILDING

(71) Applicant: QUANTITATIVE HEAT OY, Helsinki (FI)

(72) Inventor: Rami NIEMI, Helsinki (FI)

(21) Appl. No.: 17/263,212

(22) PCT Filed: Aug. 20, 2019
(86) PCT No.: PCT/FI2019/050592

§ 371 Date: Jan. 26, 2021

(30) Foreign Application Priority Data
Aug. 20, 2018 (FI) 20185691

(51) Int. Cl. F24F 5/00; F24T 10/10; F24F 1/60; F25B 30/06; F24T 50/00

(52) U.S. Cl. CPC F24F 5/0046; F24T 10/10; F24T 50/00; F25B 30/06; F24F 1/60

(57) ABSTRACT

A method and arrangement for conditioning a building space of a building includes extracting heat energy from the building space to heat pump working fluid with a primary heat exchange connection of a heat pump and releasing heat energy from the heat pump working fluid with a secondary heat exchange connection of the heat pump to geothermal working fluid of a geothermal heat exchanger. The method further includes releasing heat energy from the geothermal working fluid to ground at lower part of the ground hole having depth at least 300 meters, producing solar energy with a solar energy apparatus provided to the building, and supplying the solar energy to the heat pump or to the geothermal heat exchanger.

### FIELD OF THE INVENTION

The present invention relates to a method in connection with a building and more particularly to a method as disclosed in the preamble of claim 1. The present invention further relates to an arrangement in connection with a building and more particularly to an arrangement as disclosed in the preamble of claim 9.

### BACKGROUND OF THE INVENTION

Geothermal heating is commonly used for heating buildings and building spaces. Temperature of the ground increases as function of depth from the ground surface. Geothermal heating is based on extracting heat from a certain depth of the ground by utilizing a ground hole extending into the ground and releasing the heat in a heat pump to be used in the buildings or building spaces. The geothermal heating is usually carried out using a geothermal heat exchanger having a piping arrangement arranged into the ground hole. Working fluid is circulated in the piping arrangement such that the working fluid flows into the ground hole in which it receives heat energy from the ground. The working fluid further flows back to the ground surface carrying the heat energy. Then the working fluid releases heat energy in the heat pump to heat pump working fluid and flows again into the ground hole for extracting heat. The heat pump further releases the heat energy to the building or the building space for heating.

As mentioned above, geothermal heating apparatuses enable utilizing heat existing in the ground for heating building or building spaces when the geothermal heating process is utilized in heating mode. However, the geothermal heat exchanger also consumes energy for circulating the working fluid and operating the geothermal heat exchanger. Further, also the heat pump consumes energy for circulating the working fluid of the heat pump and operating the heat pump. These energy consumptions lower the overall efficiency of the geothermal heating apparatus. Normally, electricity is used for operating the heat pump, geothermal heat exchanger and the pumps. Additionally, local temperature in the ground surrounding the ground hole, especially at lower part of the ground hole, decreases over time when heat is extracted from the ground. This further decreases overall efficiency of geothermal heating and the geothermal heating apparatus.

### BRIEF DESCRIPTION OF THE INVENTION

An object of the present invention is to provide a method and arrangement for solving or at least alleviating the prior art disadvantages. The objects of the invention are achieved by a method in connection with a building for conditioning a building space of the building which is characterized by what is stated in the independent claim 1. The objects of the invention are further achieved by an arrangement in connection with a building for conditioning a building space of the building which is characterized by what is stated in the independent claim 9.

The preferred embodiments of the invention are disclosed in the dependent claims.

The invention is based on the idea of a method in connection with a building for conditioning a building space of the building. The method comprises steps:

a) performing a first heat exchange step in which heat energy is extracted from primary working fluid of the building space to a geothermal working fluid with a heat pump for cooling the building space and for heating the geothermal working fluid.

The method also comprises step b) of circulating the heated geothermal working fluid in a geothermal heat exchanger into a ground hole in a rise pipe provided with a first thermal insulation along at least part of the length of the rise pipe.

Accordingly, the geothermal heating process is in cooling mode as thermal energy is extracted from the building space. In the cooling mode, the net energy consumption may be considered negative as operating the heat pump in cooling mode consumes energy.

The method further comprises steps:

c) performing a second heat exchange step in which heat energy is released from the heated geothermal working fluid in the geothermal heat exchanger to ground in the ground hole and the geothermal working fluid is cooled;

d) producing solar energy with a solar energy apparatus provided in connection with the building; and

e) supplying the solar energy produced in step d) to the heat pump or to the geothermal heat exchanger or to the heat pump and the geothermal heat exchanger.

According to the above mentioned, the geothermal heat exchanger operates in charging mode and thermal energy is released to the ground in the ground hole. The first thermal insulation of the rise pipe enables preventing heat transfer or release along the rise pipe and this the thermal energy may be released to the ground in the lower part of the ground hole and the thermal energy does not escape along the rise pipe. The produced solar energy is used for operating the heat pump and/or the geothermal heat exchanger or pumps thereof or for heating the geothermal working fluid flowing into the ground hole in the rise pipe. Accordingly, the overall efficiency of the geothermal heating apparatus may be increased and solar energy may be utilized to release heat into the ground hole. This way it may be considered that solar energy or solar heat energy is supplied to the ground and ground hole. This enables increasing the temperature of the ground surrounding the ground hole, especially in the lower part of the ground hole, and preferably in the depth of at least 300 meters, or at least 600 meter or more preferably at least 1000 meters.

The solar energy apparatus may be a solar electricity apparatus and the step d) may comprise producing electricity with the solar electricity apparatus. Therefore, the electricity produced with the solar electricity apparatus may be utilized in operating the heat pump and/or the geothermal heat exchanger or the pumps thereof. Furthermore, the step e) may comprise supplying the electricity produced with the solar electricity apparatus to a building electricity network of the building or directly to the heat pump or to the geothermal heat exchanger or to the heat pump and the geothermal heat exchanger.

Accordingly, the step e) may thus comprise supplying the electricity produced with the solar electricity apparatus to the heat pump for operating the heat pump in a cooling mode in which the heat energy is extracted from the primary working fluid of the building space.

Alternatively, the step e) may comprise supplying the electricity produced with the solar electricity apparatus to the heat pump for operating the heat pump in a cooling mode in which the heat energy is extracted from the primary working fluid of the building space to heat pump working fluid with a primary heat exchange connection of a heat pump and released from the heat pump working fluid with a secondary heat exchange connection of the heat pump. Thus, the electricity produced with the solar electricity apparatus may be used in the heat pump for any operations which need electricity, such as controlling the operation of the heat pump or a pump of the heat pump for circulating the heat pump working fluid or using a fan or the like for sucking for example air from the building space to the heat pump.

Further alternatively, the step e) may comprise supplying the electricity produced with the solar electricity apparatus to the geothermal heat exchanger for operating the geothermal heat exchanger in a charging mode in which heat energy is released from the geothermal working fluid of the geothermal heat exchanger to ground in the ground hole. Thus, the electricity produced with the solar electricity apparatus may be used in the geothermal heat exchanger for any operations which need electricity, such as controlling the operation of the geothermal heat exchanger or a pump of the geothermal heat exchanger for circulating the geothermal working fluid.

Further, the step e) may comprise supplying the electricity produced with the solar electricity apparatus to a heating device provided in connection with the geothermal for operating the heating device and heating the geothermal working fluid flowing in the rise pipe to the ground hole with the heating device. Therefore, the electricity produced with solar electricity apparatus may be utilized in heating device arranged to heat the geothermal working fluid flowing from the in the rise pipe to the ground hole in the geothermal heat exchanger.

It should be noted, that the above identified alternatives for utilizing the electricity produced with the solar electricity apparatus may be combined such that electricity is supplied to two or more of the building electricity network heat pump, geothermal heat exchanger and the heating device.

Further, it should be noted that the building electricity network is the electricity network of the building and not a nationwide or local area electricity network. The building electricity network is connected to a nationwide or local area with a building junction. The building junction defines the boundary point between the building electricity network and a nationwide or local area electricity network.

The solar energy apparatus may be a solar heating apparatus and the step d) may comprises heating a solar working fluid of the solar heating apparatus. Accordingly, the thermal energy of the solar energy or solar radiation is utilized in the solar heating apparatus for heating the solar working fluid. Therefore, the solar heating apparatus may produce heat or heated solar working fluid to be used in the geothermal heating apparatus.

Accordingly, the step e) may comprise performing a fourth heat exchange step in which the geothermal working fluid flowing in the rise pipe into the ground is heated with the solar working fluid of the solar heating apparatus. Thus, the temperature of the geothermal working fluid is increased by heating the geothermal working fluid flowing into the ground hole when the heat pump is operated in cooling mode and the geothermal heat exchanger in the charging mode.

Alternatively, the step e) may comprise performing a fourth heat exchange step with a solar heat exchanger in which a solar heat exchanger is utilized for heating the geothermal working fluid flowing in the rise pipe into the ground hole with the solar working fluid of the solar heating apparatus. Thus, the solar heat exchanger may be arranged in connection with the geothermal heat exchanger or in heat transfer connection with the geothermal working fluid such that the heated solar working fluid of the solar heating apparatus may release thermal energy to the geothermal working fluid downstream of the heat pump or flowing to the ground hole in the rise pipe when the heat pump is operated in cooling mode and the geothermal heat exchanger in the charging mode.

Further, the solar energy apparatus comprises the solar electricity apparatus and the solar heating apparatus, and the step e) comprises supplying electricity produced with the solar electricity apparatus directly to the solar heating apparatus or to the building electricity network of the building for operating the solar heating apparatus, such as circulating the solar working fluid. It should be noted, that the electricity produced with the solar electricity apparatus may also be used additionally to the above mentioned manner and purposes.

The method of the present invention may further comprise step f) of performing a fifth heat transfer step in which waste heat energy produced in the building is transferred to the geothermal working fluid flowing in the rise pipe into the ground hole. Accordingly, the waste heat may be used for heating the geothermal working fluid flowing into the ground hole when the heat pump is operated in cooling mode and the geothermal heat exchanger in the charging mode. The waste heat may be for example waste heat of a ventilation system of the building or waste heat produced by devices in the building.

Alternatively, the step f) may comprise performing a fifth heat transfer step by utilizing waste heat exchanger for transferring waste heat energy produced in the building is transferred to the geothermal working fluid flowing in the rise pipe into the ground hole. Thus, the waste heat exchanger may be arranged in connection with the geothermal heat exchanger or in heat transfer connection with the geothermal working fluid such that waste heat energy may be released to the geothermal working fluid flowing into the ground hole heat pump when the heat pump is operated in cooling mode and the geothermal heat exchanger in the charging mode.

Performing the steps b) and c) may comprises:
circulating the geothermal working fluid in the geothermal heat exchanger comprising a piping arrangement having the rise pipe arranged into the ground hole and a drain pipe arranged in the ground hole, the rise pipe and the drain pipe being arranged in fluid communication with each other for circulating the geothermal working fluid in the ground hole for performing the second heat exchange step, the ground hole extending from ground surface into the ground and having a lower end; and
operating the geothermal heat exchanger in a charging mode by circulating the geothermal working fluid in a direction downwards in the rise pipe and in a direction upwards in the drain pipe for transporting the heated geothermal working fluid towards the lower end of the ground hole such that the heated geothermal working fluid receives thermal energy from the heat pump working fluid in the second heat exchange step and in which the geothermal working fluid releases heat energy to the ground in the second heat exchange step.

According to the above mentioned, thermal energy is transported with the geothermal working fluid into the ground hole by circulating the geothermal working and further the thermal energy is released in the ground hole to the ground, especially in the lower part of the ground hole.

Circulating the geothermal working fluid in the geothermal heat exchanger may comprise circulating the geothermal working fluid in the geothermal heat exchanger in which the rise pipe is provided with a first thermal insulation surrounding the rise pipe along at least part of the length of the rise pipe. The first thermal insulation of the rise pipe prevents heat transfer from the geothermal working fluid along the rise pipe where the first thermal insulation is provided. Preferably, the first thermal insulation extends along the rise pipe from the ground surface and at least part of the length of the rise pipe towards the lower end of the rise pipe and lower end of the ground hole. Thus, the geothermal working fluid may release the heat energy to the ground at the lower part of the ground hole in the third heat transfer step c).

The present invention further relates to an arrangement in connection with a building for conditioning a building space of the building. The arrangement comprises a ground hole provided into the ground and extending into the ground from the ground surface and having a lower end. The arrangement further comprises a geothermal heating apparatus having a geothermal heat exchanger arranged in heat exchange connection with ground and a heat pump arranged in heat exchange connection with the geothermal heat exchanger and with a primary working fluid of the building space of the building.

The geothermal heat exchanger of the geothermal heating apparatus comprises a piping arrangement comprising a rise pipe having a lower end and arranged into the ground hole and a drain pipe having a lower end a, the lower end of the rise pipe and the lower end of the drain pipe being arranged in fluid communication with each other for circulating the geothermal working fluid in the ground hole along the rise pipe and the drain pipe.

The arrangement further comprises a solar energy apparatus provided in connection with the building and connected to the geothermal heat exchanger or to the heat pump, or the heat pump and the geothermal heat exchanger for supplying solar energy to the geothermal heating apparatus. Accordingly, solar energy is utilized for operating the heat pump or the geothermal heat exchanger. This way external energy consumption of the heat pump or geothermal heat exchanger may be minimized or even omitted. This enables conditioning the building space using a combination of geothermal heat and solar energy.

The rise pipe of the piping arrangement of the geothermal heat exchanger is arranged inside the drain pipe and provided with a first thermal insulation surrounding the rise pipe and extending along at least part of the length of the rise pipe.

The geothermal heat exchanger of the geothermal heating apparatus further comprising a first pump connected to the piping arrangement and arranged to circulate the geothermal working fluid in the rise pipe and in the drain pipe. The first pump is arranged to circulate the geothermal working fluid in a direction towards the lower end of the ground hole in the rise pipe provide with the first thermal insulation and towards the ground surface in the drain pipe. Accordingly, the geothermal heat exchanger is arranged into deep ground hole having high temperature at the lower part of the ground hole. The geothermal working fluid transports heat along the rise pipe towards the lower end of the rise pipe and the lower part of the ground hole.

The arrangement may comprise a ground hole provided into the ground and extending into the ground from the ground surface and having a lower end. The depth of the ground hole is at least 300 meters, or at least 600 meter, or at least 1000 meters.

The rise pipe of the piping arrangement of the geothermal heat exchanger may be provided with the first thermal insulation surrounding the rise pipe and extending along at least part of the length of the rise pipe. Further, the rise pipe of the piping arrangement of the geothermal heat exchanger may be provided with the first thermal insulation surrounding the rise pipe and extending along at least part of the length of the rise pipe from the ground surface. The first thermal insulation prevents heat transfer of the geothermal working fluid in the rise pipe.

Alternatively, the rise pipe of the piping arrangement of the geothermal heat exchanger may be an evacuated tube comprising a vacuum layer surrounding a flow channel of the rise pipe. The vacuum layer is arranged to form the first thermal insulation surrounding the rise pipe and extending along at least part of the length of the rise pipe from the ground surface. The vacuum layer prevents heat transfer of the geothermal working fluid in the rise pipe.

The rise pipe of the piping arrangement of the geothermal heat exchanger comprises an insulation material layer on outer surface of the rise pipe. The insulation material layer is arranged to form the first thermal insulation surrounding the rise pipe and extending along at least part of the length of the rise pipe from the ground surface. Alternatively, the rise pipe of the piping arrangement of the geothermal heat exchanger comprises an insulation material layer on inner surface of the rise pipe, the insulation material layer arranged to form the first thermal insulation surrounding the rise pipe and extending along at least part of the length of the rise pipe from the ground surface.

Further alternatively, the rise pipe of the piping arrangement of the geothermal heat exchanger may comprise an inner pipe wall, an outer pipe wall and an insulation material layer provided between the inner pipe wall and the outer pipe wall of the rise pipe. The insulation material layer is arranged to form the first thermal insulation surrounding the rise pipe and extending along at least part of the length of the rise pipe.

The solar energy apparatus may be a solar electricity apparatus. The solar electricity apparatus may be connected to the building electricity network of the building and the heat pump or the geothermal heat exchanger or the heat pump and the geothermal heat exchanger are connected to the building electricity network of the building.

Alternatively, the solar electricity apparatus may be connected directly or via the building electricity network to the heat pump of the geothermal heating apparatus and arranged to operate the heat pump. Accordingly, the electricity produced with the solar electricity apparatus may be used for operating the heat pump in a cooling mode in which heat energy is extracted from the building space.

Alternatively, the solar electricity apparatus may be connected directly or via the building electricity network to the geothermal heat exchanger of the geothermal heating apparatus and arranged to operate the geothermal heat exchanger. Accordingly, the electricity produced with the solar electricity apparatus may be used for operating the geothermal heat exchanger in charging mode in which heat is released to the ground.

Yet alternatively, the solar electricity apparatus may be connected directly or via the building electricity network to the first pump of the geothermal heat exchanger of the geothermal heating apparatus and arranged to circulate the geothermal working fluid in a direction towards the lower end of the ground hole in the rise pipe and towards the ground surface in the drain pipe. Therefore, the pump operates the geothermal heat exchanger in charging mode in which heat is released to the ground by utilizing the solar energy.

Further alternatively, the solar electricity apparatus may be connected directly or via the building electricity network to the electrical heating device provided in connection with the geothermal heat exchanger. The electrical heating device may be arranged to heat the geothermal working fluid flowing in the rise pipe of the geothermal heat exchanger. Thus, the electricity produced with the solar electricity apparatus may be used directly to heat the geothermal working fluid of the geothermal heat exchanger.

Further, the solar electricity apparatus may be connected directly or via the building electricity network to the electrical heating device provided to or in connection with the rise pipe of the geothermal heat exchanger, the electrical heating device being arranged to heat the geothermal working fluid in the rise pipe of the geothermal heat exchanger.

The solar electricity apparatus may be integral part of the building. Therefore, the whole arrangement may be provided as part of the structure of the building for constructing the building as self-energy sufficient as possible.

The solar electricity apparatus may be integral part of the building and connected to the building electricity network of the building.

The solar electricity apparatus may comprise one or more solar panels or solar cells arranged produce electricity and arranged to the structure of the building. Alternatively, the solar electricity apparatus may comprise a solar roof, a solar window or a solar wall. The solar roof, the solar window or the solar wall forming at least part of the structure of the building and arranged to produce electricity. Accordingly, the building itself may produce electricity for the geothermal heating apparatus.

The solar energy apparatus may also be a solar heating apparatus arranged to heat solar working fluid.

The solar heating apparatus may be provided in connection with the geothermal heat exchanger and arranged to transfer heat energy from the solar heating apparatus to the geothermal heat exchanger or to the geothermal working fluid flowing in the rise pipe of the geothermal heat exchanger.

The solar heating apparatus may be connected to the geothermal heat exchanger with a solar heat exchange connection. The solar heat exchange connection may be arranged to transfer heat energy from the solar heating apparatus to the geothermal heat exchanger or to the geothermal working fluid flowing in the rise pipe of the geothermal heat exchanger. Alternatively, the solar heating apparatus may be connected to the geothermal heat exchanger with a solar heat exchange connection. The solar heat exchange connection may be arranged to transfer heat energy from solar working fluid of the solar heating apparatus to the geothermal working fluid of the geothermal heat exchanger. Accordingly, the heat energy produced with the solar heating apparatus may be used for heating the geothermal working fluid.

Alternatively, the solar heating apparatus may be connected to the geothermal heat exchanger with a solar heat exchange connection provided in connection with the rise pipe of the geothermal heat exchanger. The solar heat exchange connection may be arranged to transfer heat energy from solar working fluid of the solar heating apparatus to the geothermal working fluid of the geothermal heat exchanger or to the geothermal working fluid flowing in the rise pipe of the geothermal heat exchanger. Accordingly, the heat energy produced with the solar heating apparatus may be used for heating the geothermal working fluid in the rise pipe.

The building space conditioning arrangement may comprise a waste heat exchanger connected to a waste heat source in the building. Therefore, waste energy produced in the building may be utilized for heating the geothermal working fluid.

The waste heat exchanger may be provided in connection with the geothermal heat exchanger and arranged to transfer waste heat energy to the geothermal heat exchanger.

The waste heat exchanger may be provided in connection with the geothermal heat exchanger and arranged to transfer heat energy from the waste heat source to the geothermal heat exchanger. Alternatively, the waste heat exchanger may be provided in connection with the geothermal heat exchanger and arranged to transfer heat energy from waste heat fluid to the geothermal working fluid of the geothermal heat exchanger or to the geothermal working fluid flowing in the rise pipe of the geothermal heat exchanger. Therefore, waste energy produced in the building may be utilized for heating the geothermal working fluid with the waste heat exchanger.

The waste heat exchanger may be provided to or in connection with the rise pipe of the geothermal heat exchanger and arranged to transfer heat energy from waste heat fluid to the geothermal working fluid of the geothermal heat exchanger or to the geothermal working fluid flowing in the rise pipe of the geothermal heat exchanger. Therefore, waste heat fluid produced in the building may be utilized for heating the geothermal working fluid with the waste heat exchanger.

The building space conditioning arrangement comprises the solar electricity apparatus and the solar heating apparatus. The solar electricity apparatus may be connected directly to the solar heating apparatus or to the building electricity network and arranged to operate the solar heating apparatus. Alternatively, the solar electricity apparatus may be connected directly to a second pump of the solar heating apparatus. The second pump being arranged to circulate solar working fluid. Thus, electricity and heat produced using solar electricity apparatus maybe used for operating the solar heating apparatus for increasing efficiency.

In the present invention, solar energy produced with a solar energy apparatus of the building is utilized for operating the geothermal heating apparatus or in the geothermal heating apparatus. This increases the energy efficiency of the geothermal heating apparatus and energy self-sufficiency of the building as the amount of external energy for heating the building may be decreased. Furthermore, in the cooling mode of the heat pump and in the charging mode of the geothermal heat exchanger the thermal energy transported from the building space into the ground hole in the at least partly insulated rise pipe and released in the ground hole increases local temperature of the ground surrounding the ground hole, especially in the lower part of the ground hole. This increases the efficiency of the geothermal heat exchanger in heat extraction mode of the geothermal heat exchanger as the ground surrounding the ground hole may be provided in higher temperature. This is achieved as the insulated rise pipe allows transporting the geothermal working fluid in to the ground hole or to the lower part thereof at a high temperature. Heat flux towards the ground hole in the lower part of the ground hole also prevents heat released in the ground hole from the geothermal working fluid from escaping and temperature of the ground surrounding the ground may be restored after extracting heat in the extraction mode of the geothermal heat exchanger. Therefore, the ground hole may be used as heat storage and solar energy may be stored to the ground hole.

### BRIEF DESCRIPTION OF THE DRAWINGS

The invention is described in detail by means of specific embodiments with reference to the enclosed drawings, in which

FIG. 1 shows schematically a geothermal heating arrangement in connection with a building;

FIG. 2 shows schematically a heat pump of a geothermal heating arrangement;

FIG. 3 shows schematically one embodiment of an arrangement for conditioning a building space of the building according to the present invention;

FIGS. 4A and 4B show schematically other embodiments of an arrangement for conditioning a building space of the building according to the present invention;

FIGS. 5A and 5B show schematically further embodiments of an arrangement for conditioning a building space of the building according to the present invention;

FIGS. 6A and 6B show schematically alternative embodiments of an arrangement for conditioning a building space of the building according to the present invention;

FIGS. 7A and 7B show schematically further alternative embodiments of an arrangement for conditioning a building space of the building according to the present invention;

FIGS. 8A and 8B show schematically still other alternative embodiments of an arrangement for conditioning a building space of the building according to the present invention;

FIGS. 9 to 11 show schematically different embodiments of a geothermal heating arrangement to be utilized in the arrangement for conditioning a building space of the building according to the present invention; and

### DETAILED DESCRIPTION OF THE INVENTION

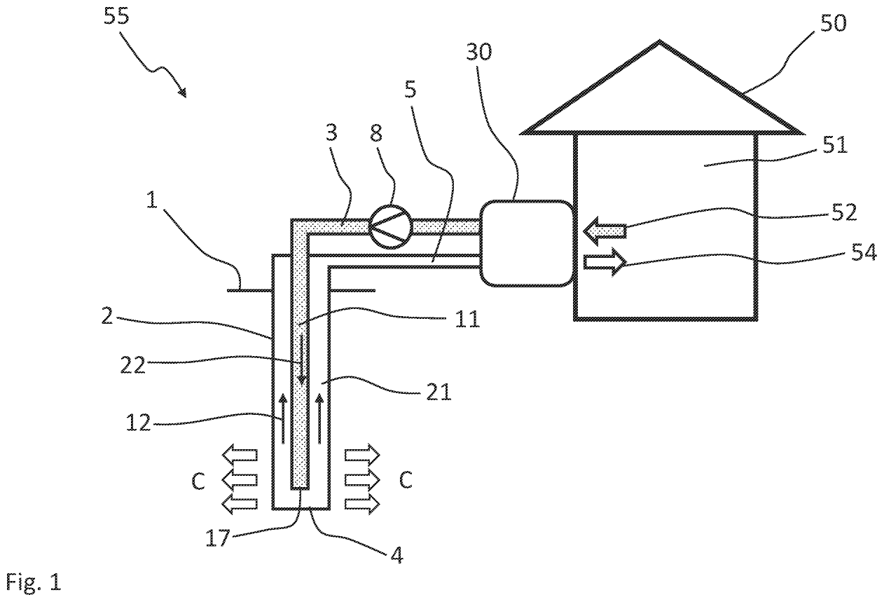

FIG. 1 shows a conventional prior art geothermal heating apparatus in connection with a building 50. The geothermal heating arrangement comprises ground hole 2 or bore hole provided to the ground and extending downwards into the ground from the ground surface 1. The ground hole 2 may be formed by drilling or some other excavating method.

In the context of the present application the depth of the ground hole 2 from the ground surface 1 may be at least 300 m, or at least 500 m, or between 300 m and 3000 m, or between 500 m and 2500 m. Alternatively or additionally, the ground hole 2 extends into the ground to a depth in which the temperature is at least 15° C., or approximately 20° C., or at least 20° C.

The ground hole 2 may extend to a depth under the water table in the ground, meaning through the water table. Alternatively, the ground hole 2 may extend to a depth above the water table in the ground.

It should be noted that in the figures similar structural part and structures are denoted with same reference numerals and their description is not repeated in relation to every figure.

Further, in the present application the ground hole 2 may be any kind of hole extending into the ground it may be vertical hole, straight vertical or otherwise straight hole extending into the ground in an angle to the ground surface 1 or to the vertical direction. Furthermore, the ground hole 2 may be may have one or more bends and the direction of the ground hole may change one or more times along the length of the ground towards the lower end or bottom of the ground hole 2. Additionally, it should be noted that shape or form a rise pipe and a drain pipe may of a geothermal heat exchanger preferably conform the shape or form of the ground hole 2, at least substantially, in order to provide proper installation of the rise pipe and the drain pipe into the ground hole 2. Preferably, the ground hole 2 extends to a depth as mentioned above, but it may one or more bends along the length or it may be straight.

The ground material at the lower end 4 of the ground hole is usually rock material. Accordingly, the ground or the rock material of the ground may form surface of the ground hole or inner surface of the rise pipe or the drain pipe of the geothermal heat exchanger along at least part of the length of the rise pipe or the drain pipe.

There is a geothermal heat exchanger 55 arranged in connection with the ground hole 2. The geothermal heat exchanger 55 comprises a piping arrangement in which a geothermal working fluid is circulated. The piping arrangement usually comprises a closed loop piping arranged to provide closed circulation of the geothermal working fluid. The geothermal working fluid is usually a liquid, such as water or methanol or ethanol based working fluids. The piping arrangement comprises a rise pipe 11 and a drain pipe 21 arranged into the ground hole 2 such that they extend from the ground surface 1 towards a bottom 4 of the ground hole 2. The rise pipe 11 and the drain pipe 21 are in fluid communication with each other at the lower ends of the rise pipe 11 and the drain pipe 21 for circulating the geothermal working fluid in ground hole 2 between the rise pipe 11 and the drain pipe 21. There may be one or more rise pipes 11 and drain pipe 21 arranged into the same or different ground holes 2.

In preferred embodiments, the ground hole 2 forms the drain pipe 21. Alternatively, the ground hole 2 forms a at least part of the drain pipe 21 and there is a separate upper drain pipe (not shown) arranged into the upper part of the ground hole 2 and extending a predetermined distance from the ground surface 1 into the ground hole 2.

Accordingly, the rise pipe 11 is arranged inside the ground hole 2. The rise pipe 11 is open at the lower end 17. Thus, the rise pipe 11 and the drain pipe 21 or the ground hole 2, are in fluid communication with each other via the open lower end 17 of the rise pipe 11. The advantage of providing the ground hole 2 as the drain pipe is that the geothermal working fluid is in direct contact with the ground providing efficient heat transfer. Further, when the ground hole 2 is deep, installing a separate drain pipe may be difficult.

The geothermal heat exchanger 55 further comprises a first pump 8 arranged to the piping arrangement 11, 21 for circulating the geothermal working fluid in the piping arrangement. The first pump 8 may be any kind of known pump capable of circulating the geothermal working fluid.

The geothermal heat exchanger 55 is further connected to a heat pump 30 in which heat exchange is carried out between the geothermal working fluid and a heat pump working fluid. Furthermore, in the heat pump 30 heat exchange is carried out between the heat pump working fluid and a primary working fluid of a building space 51 of the building 50.

In FIG. 1, the geothermal heat exchanger 55 and the heat pump 30 are arranged in connection with the building 50. The geothermal heat exchanger 55 is used for heating or cooling the primary working fluid of the building space 51. The primary working fluid of the building space 51 may be form example ventilation air of the building or building space or some other primary working fluid flowing in a heating and/or cooling system of the building 51 or the building space 51.

The heat pump 30 and the geothermal heat exchanger 55 together form the geothermal heating apparatus. The heat pump 30 and the rise pipe 11 may be connected to each other with a first connection pipe 3 and the heat pump 30 and the drain pipe 21 may be connected to each other with a second connection pipe 5. The first connection pipe 3 may form part of the rise pipe 11 and the second connection pipe 5 may form part of the drain pipe 5. The first pump 8 is provided to the rise pipe 11 or the first connection pipe 3. Alternatively, the first pipe may be provided to the drain pipe 21 or the second connection pipe 5.

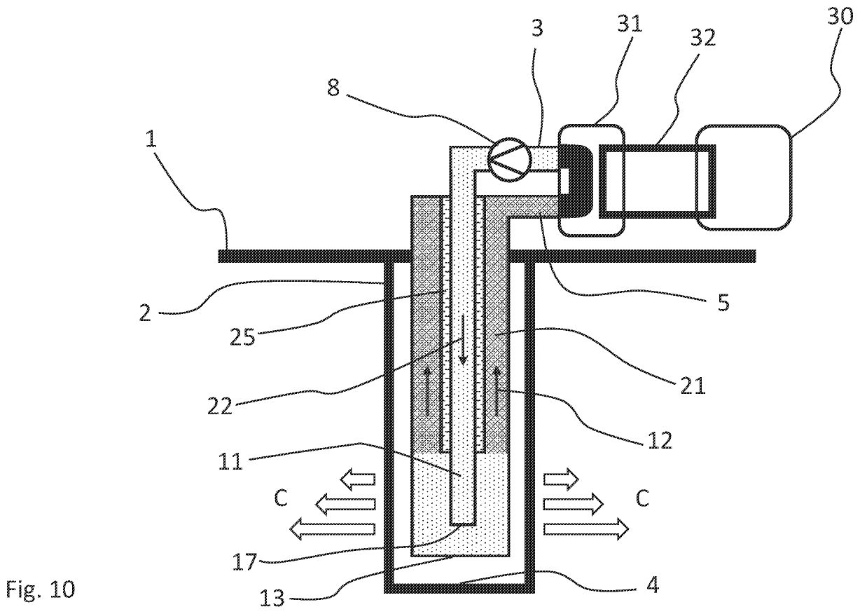

As shown in FIGS. 1 to 9 and 11, the geothermal working fluid of the geothermal heat exchanger may be arranged to circulate in the heat pump 30. Accordingly, the rise pipe 11 and the drain pipe 21 may be connected directly to the heat pump 30. Alternatively, as shown in FIG. 10, there may be an additional heat exchanger, a secondary heat exchanger, 31 provided between the heat pump 30 and the geothermal heat exchanger 55. The geothermal heat exchanger 55 is connected to the secondary heat exchanger 31 such that the geothermal working fluid is provided in heat transfer connection with a secondary working fluid flowing in a secondary piping circuit 32. The secondary piping circuit 32 is connected to the heat pump 30 and to the secondary heat exchanger 31 such that the secondary working fluid may transfer heat energy to and from the heat pump 30, or the primary working fluid, and to and from the secondary heat exchanger 31, or the geothermal working fluid. In the following, all the embodiments may be carried out as shown in FIG. 1 or as shown in FIG. 10. Thus, the secondary working fluid is equivalent with the geothermal working fluid and the secondary piping circuit is equivalent with the first and second connection pipes 3, 5 and the rise pipe 11 and the drain pipe 21.

Accordingly, the first heat exchanger step of the method of the present invention may comprise performing the first heat exchange step in which heat energy is extracted from a primary working fluid of the building space 51 to a geothermal working fluid with a heat pump 30 for cooling the building space 51 and for heating the geothermal working fluid. Alternatively, the first heat exchange step may comprise further utilizing the secondary heat exchanger 31 and the secondary piping circuit 32 and the secondary working fluid. Thus, the first heat exchange may comprise extracting heat energy from a primary working fluid of the building space 51 to the secondary working fluid and further from the secondary working fluid to the geothermal working fluid. This may be carried out by extracting heat energy with the heat pump 30 from the primary working fluid of the building space 51 to the secondary working fluid circulated in the secondary piping circuit 32 and further carrying out heat exchange with the secondary heat exchanger 31 from the secondary working fluid to the geothermal working fluid. Therefore, in the present invention the first heat exchange step comprises all possible intermediate heat exchange steps between the primary working fluid and the geothermal working fluid.

In a heating mode of the heat pump 30 and in heat extraction mode of the geothermal heat exchanger the geothermal working fluid receives or extracts thermal energy from the ground in the ground hole 2, especially in the lower part or in vicinity of the lower end 4 of the ground hole 2, such that the temperature of the geothermal working fluid increases and the geothermal working fluid is heated. Then the geothermal working fluid is circulated or transported along the rise pipe 11 upwards and via the first connection pipe 3 to the heat pump 30.

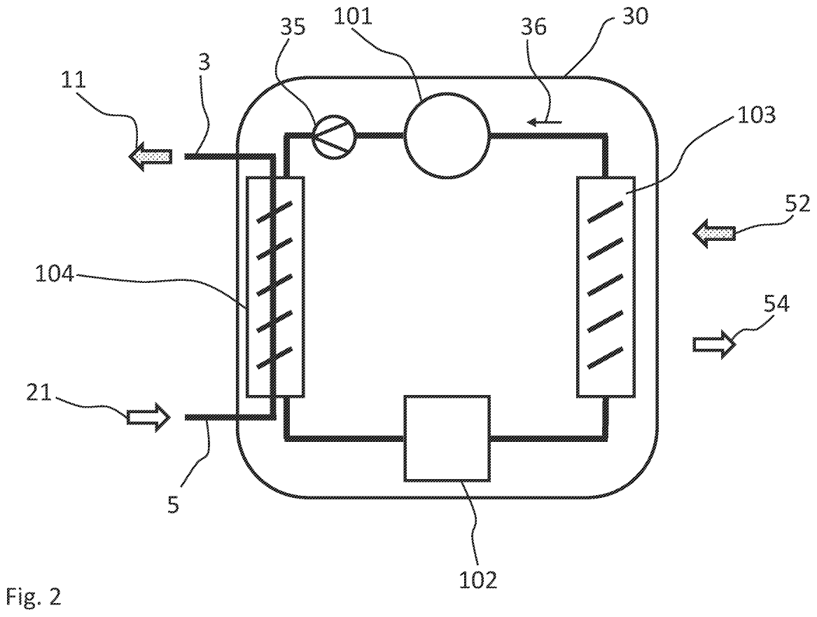

FIG. 2 shows schematically one embodiment of the heat pump 30 in connection with the building 50 and the geothermal heat exchanger.

In the heating mode of the heat pump 30 and in heat extraction mode of the geothermal heat exchange, in the heat pump 30 the geothermal working fluid releases thermal energy to the heat pump working fluid. The heat pump working fluid receives thermal energy from the geothermal working fluid in a secondary heat exchange connection 104 of the heat pump 30. The heat pump working fluid may be any suitable fluid such as refrigerant. The heat pump 30 may comprise a pump 35 provided to the heat pump 30 for circulating the heat pump working fluid in the heat pump 30.

The secondary heat exchange connection 104 may be an evaporator and the liquid heat pump working fluid receives or absorbs thermal energy from the geothermal working fluid in the evaporator 104 and the heat pump working fluid is turns into gas or becomes gas. Then the gaseous heat pump working fluid flows or is circulated into a compressor 101 arranged to raise the pressure and increase the temperature of the gaseous heat pump working fluid.

Then the gaseous heat pump working fluid releases thermal energy to a primary working fluid of the building space 51 or building 50 in a primary heat exchange connection 103 of the heat pump 30. The primary working fluid receives thermal energy from the heat pump working fluid in the primary heat transfer connection.

The primary heat exchange connection 103 may be a condenser and the gaseous heat pump working fluid may condense back to liquid as it releases thermal energy to the primary working fluid. Then the liquid heat pump working fluid flows or is circulated to an expansion device 102 in which the pressure of the liquid heat pump working fluid is reduced and the temperature decreased.

In the heating mode of the heat pump 30 cold primary working fluid flow 52 is received into the heat pump 30 from the building 50 or the building space 51 and it receives thermal energy in the primary heat exchange connection 103 such that the temperature of the primary working fluid increases. Then the heated primary working fluid flow 54 is supplied to the building 50 or the building space 51.

Then heat pump working fluid flows or is circulated back to the secondary heat transfer connection 104 and the cycle is repeated.

The geothermal working fluid releases thermal energy in the heat pump 30, or in the secondary heat transfer connection 104 of the heat pump 30. The thermal energy is released and received to the heat pump working fluid. Therefore, the temperature of the geothermal working fluid decreases in the heat pump 30 or as it flows through the heat pump 30 or the secondary heat exchange connection 104. From the heat pump 30 the cold geothermal working fluid is circulated or flows to the drain pipe 21, via the second connection pipe 5 to the drain pipe 21, and downwards in the ground hole 2 towards the bottom 4 of the ground hole 2. In the ground hole 2 the geothermal working fluid again receives or extracts thermal energy from the ground and a new cycle is started.

FIG. 2 shows the above mentioned process in reverse mode. In the reverse mode the heat pump 30 is operated in cooling mode such that heat pump receives or absorbs heat energy from the primary working fluid of the building 50 or the building space 51. Furthermore, in the reverse mode the geothermal heat exchanger releases thermal energy to the ground in the ground hole 2. The reverse operating mode is described. In the cooling mode of the heat pump 30 the heat pump working fluid flows in the direction of arrow 36. Furthermore, in the cooling mode the primary heat exchange connection 103 is arranged to transfer thermal energy from the heat pump working fluid to the primary working fluid such that the temperature of the primary working fluid decreases and the temperature of the heat pump working fluid increases.

Liquid heat pump working fluid receives or absorbs thermal energy from the primary working fluid of the building space 51 or building 50 in a primary heat exchange connection 103 of the heat pump 30. Thus, a warm or hot flow of primary working fluid 52 releases thermal energy to the liquid heat pump working fluid in the primary heat transfer connection 103. The primary working fluid cools down or the temperature of the primary working fluid decreases. The cool primary working fluid flow 54 flows back from the heat pump 30 to the building 50 or the building space 51.

The primary heat exchange connection 103 may be now an evaporator. The liquid heat pump working fluid receives or absorbs thermal energy from the primary working fluid in the evaporator and evaporates to gas forming gaseous heat pump working fluid.

The gaseous heat pump working fluid flows or is circulated to the compressor 101. The compressor 101 is arranged to raise the pressure and to increase the temperature of the gaseous working fluid. From the compressor 101 the gaseous heat pump working fluid flows or is circulated to the secondary heat exchange connection 104. In the secondary heat exchange connection 104 high-temperature heat pump working fluid releases heat energy to the geothermal working fluid in the secondary heat exchange connection 104. Therefore, the temperature of the heat pump working fluid decreases and the heat pump working fluid returns to liquid state.

The secondary heat exchange connection 104 may be now the condenser. The gaseous heat pump working fluid releases thermal energy to the geothermal working fluid in the condenser and turns into liquid forming liquid heat pump working fluid.

When the heat pump 30 is operated in the cooling mode the geothermal heat exchanger is operated in a charging mode. In the charging mode, the geothermal working fluid flows upwards in drain pipe 21 as indicated by arrow 12 in FIG. 1, and downwards in the rise pipe 11, as indicated by arrow 22 in FIG. 1. In the charging mode of the geothermal heat exchanger the geothermal working fluid releases thermal energy to the ground in the ground hole 2, as indicated by the arrows C in FIG. 1. Therefore, the temperature of the geothermal working fluid decreases in the ground hole 2. Accordingly, the first pump 8 is arranged to circulate the geothermal working fluid along the rise pipe 11 downwards towards the bottom 4 of the ground hole 2.

As shown in FIG. 2, cooled geothermal working fluid flows or is circulated along the drain pipe 21 to the heat pump 30, or along the drain pipe 21 and via the second connection pipe 5 to the heat pump 30, as indicated by the arrow 12 in FIGS. 1 and 2. In the heat pump 30 the geothermal working fluid receives or absorbs thermal energy from the heat pump working fluid in the secondary heat exchange connection 104. The temperature of the geothermal working fluid increases in the secondary heat exchange connection 104. Then the heated geothermal working fluid flows or is circulated along the rise pipe 11 downwards into the ground hole 2, or via the first connection pipe 3 along the rise pipe 11 downwards into the ground hole 2, as indicated by arrow 22 in FIGS. 1 and 2. In the ground hole 2 the geothermal working fluid again releases thermal energy to the ground and the temperature of the geothermal working fluid decreases. The ground surrounding the ground hole 2 absorbs or receives thermal energy from the geothermal working fluid and the temperature of the ground increases. Then a new cycle of. The geothermal working fluid is started.

After the heat pump working fluid has released thermal energy to the geothermal working fluid and returned to liquid phase in the secondary heat exchange connection 104, the heat pump working fluid flows or is circulated to the expansion device 102 in which the pressure of the heat pump working fluid is decreased and the temperature of the heat pump working fluid is also decreased. Then the heat pump working fluid flows or is circulated from the expansion device 102 again to the primary heat exchange connection 103 and the heat pump working fluid cycle is repeated and starts again.

It should be noted, that in the context of the present invention the heat pump 30 may comprise only the primary and secondary heat transfer connections 103, 104. Furthermore, the primary and secondary heat transfer connections 103, 104 may comprise any know kind of heat exchangers. Accordingly, the present invention is not limited to any particular kind of heat pump 30. The heat pump 30 may be liquid-to-liquid heat pump in which both the geothermal working fluid and the primary working fluid are liquids, or liquid-to-gas (or liquid-to-air) heat pump in which the geothermal working fluid is liquid and the primary working fluid is gas, such as air.

Further, in some embodiments the heat pump 30 may be replaced or it may be a heat exchanger in which the thermal energy is transferred directly between the geothermal working fluid and the primary working fluid of the building space 51 or the building 50. Alternatively, the heat pump 30 may be replaced or it may be any known kind of heat exchange connection provided between the primary working fluid and the geothermal working fluid or the geothermal heat exchanger.

Additionally it should be noted, that the heat pump working fluid could also be omitted and the primary working fluid or the geothermal working fluid of the secondary working fluid of FIG. 10 could be circulated in the heat pump 30 via the compressor 101, the expansion device 102 and the primary and secondary heat exchange connections 103, 104.

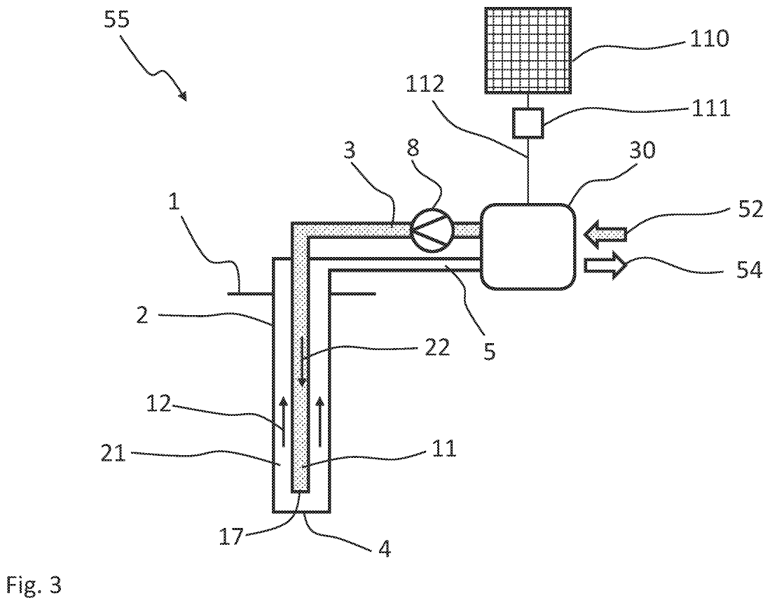

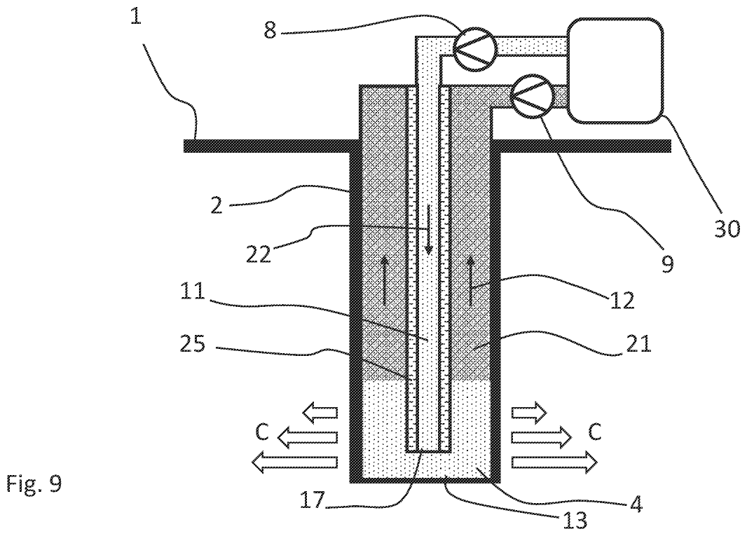

In the following FIGS. 3 to 8 the present invention and different embodiments thereof are described in more detail. The geothermal heat exchanger 55 and the heat pump 30 in FIGS. 3 to 8 correspond the general representation of FIGS. 1 and 2. Thus, repeating the above description of the geothermal heat exchanger 55 and the heat pump 30 is omitted. In all the embodiment of FIGS. 3 to 8, an arrangement for heating or cooling or conditioning the building 50 or the building space 51 of the building 50, the arrangement comprises the ground hole 2, the geothermal heat exchanger 55 and the heat pump 30. FIGS. 3 to 8 disclose different embodiment of a solar energy apparatus in connection with the geothermal heat exchanger 55 and the heat pump 30. In FIGS. 9 to 13 the geothermal heat exchanger and different embodiments thereof are described in more detail. It should be noted that the not all combination of the solar energy apparatus and the geothermal heat exchanger are disclosed separately, and therefore the different embodiments of the solar energy apparatus and the geothermal heat exchanger may be combined in all possible ways.

According to the present invention, the solar energy apparatus may be any known type of apparatus arranged to produce electricity or heat by converting solar energy to electricity or heat, respectively. For example, the solar energy apparatus may be a solar electricity apparatus arranged to produce electricity from solar energy or a solar heating apparatus arranged to produce heat energy from solar energy.

The solar electricity apparatus may comprise one or more solar panels or solar cells arranged produce electricity and arranged to the structure of the building. The solar cells or solar panels may be any known kind of solar cells or panels and the present invention is not limited to any particular type thereof.

In some embodiments of the invention, the solar electricity apparatus or the solar cells or solar panels may be provided as part of the building 50 or structure of the building 50, or as integral part of the building 50 or the structure of the building 50. Accordingly, the solar energy apparatus may be attached or installed to the building 50 or to the structure of the building, such as roof of the building 50, for providing the solar electricity apparatus to the building 50. Alternatively, the building 50 itself or part of the building 50 itself or the structure or part of the structure itself forms solar electricity apparatus or part thereof. Accordingly, the solar electricity apparatus may comprise a solar roof, solar window or a solar wall. The solar roof or the solar wall forms at least part of the structure of the building 50 and arranged to produce electricity. This means, that the integral solar electricity apparatus or the solar roof, the solar window or solar wall is normal part of the building and arranged to produce electricity.

The solar heating apparatus may comprise one or more solar collectors or collector tubes arranged to collect solar heat energy and to heat solar working fluid in the solar heating apparatus. The solar heating apparatus may be arranged to the structure of the building. The solar heating apparatus may be any known kind of solar heating apparatus and the present invention is not limited to any particular type thereof.

In some embodiments of the invention, the solar heating apparatus or the solar collector apparatus may be provided as part of the building 50 or structure of the building 50, or as integral part of the building 50 or the structure of the building 50. Accordingly, the solar heating apparatus may be attached or installed to the building 50 or to the structure of the building, such as roof of the building 50, for providing the solar heating apparatus to the building 50. Alternatively, the building 50 itself or part of the building 50 itself or the structure or part of the structure itself forms solar heating apparatus or part thereof. Accordingly, the solar heating apparatus may comprise for example a wall or roof element having integral or embedded solar heating apparatus or solar collector or collector pipes of the solar collector. The wall or roof element forms at least part of the structure of the building 50 and arranged to produce heat or heated solar working fluid. This means, that the integral solar heating apparatus is normal part of the building and arranged to produce heat or heated solar working fluid.

FIG. 3 shows one embodiment of the present invention in which the arrangement comprises a solar energy apparatus 110. The solar energy apparatus 110 is a solar electricity apparatus 110 arranged to produce electricity. The solar electricity apparatus 110 is provided in connection with or provided to the building 50 and connected to the heat pump 30 for supplying solar energy, produced solar electricity, to the geothermal heating apparatus, and especially to the heat pump 30. Accordingly, the solar electricity apparatus 110 is connected to the heat pump 30 of the geothermal heating apparatus and arranged to operate the heat pump 30. The solar electricity apparatus 110 is connected to the heat pump 30 electric connection 112 or electric cable 112. Accordingly, the solar electricity apparatus 110 is arranged to supply electricity to the heat pump 30 for operating the heat pump 30.

As shown in FIG. 3, the solar electricity apparatus 110 may be provided or it may comprise battery 111 for storing electricity produced with the solar electricity apparatus such that the electricity may be used when needed.

The battery 111 may be provided any of the embodiment of the present invention in which electricity produced with the solar electricity apparatus 110. For simplicity, the battery is not shown separately in all the embodiments, but may be provided to any of the embodiments.

The solar electricity apparatus 110 may be connected to the heat pump 30 such that the heat pump may utilize the electricity from the solar electricity apparatus to all operations and components of the heat pump 30. Alternatively, the solar electricity apparatus 110 may be connected to one or more of the following and for operating them: the compressor 101, expansion device 102, a control device (not shown), the primary heat exchange connection 103, the secondary heat exchange connection 104 or the pump 35 or some other device of the heat pump 30, for operating the heat pump 30. The control device may be any device arranged to control the operation of the heat pump 30. This concerns all the embodiment of the present invention in which the solar electricity apparatus 110 is connected to the heat pump 30.

According to the above mentioned FIG. 3 shows an embodiment in which the electricity produced with the solar electricity apparatus 110 is utilized for operating the heat pump 30 in the cooling mode. The thermal energy is thus transferred from the building 50 or the building space 51 via the heat pump 30 to the geothermal working fluid and further to the ground in the ground hole 2 as the geothermal heat exchanger 55 is operated in the charging mode. Therefore, the solar energy is stored to the ground with the solar electricity apparatus 110, heat pump 30 and the geothermal heat exchanger 55.

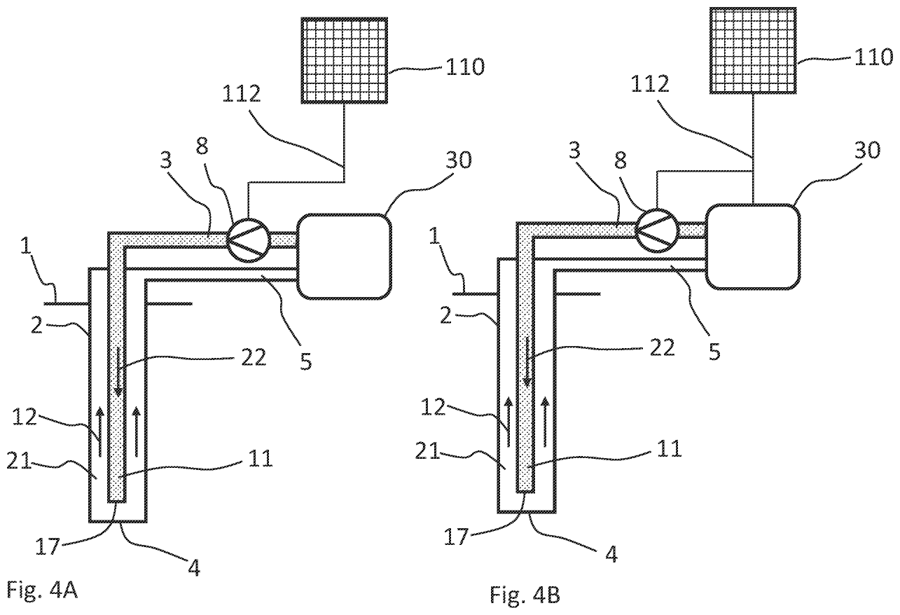

FIG. 4A shows an alternative embodiment in which the arrangement comprises the solar energy apparatus 110. The solar energy apparatus 110 is the solar electricity apparatus 110 arranged to produce electricity. The solar electricity apparatus 110 is provided in connection with or provided to the building 50 and connected to the geothermal heat exchanger 55 for supplying solar energy, produced solar electricity, to the geothermal heating apparatus, and especially to the geothermal heat exchanger 55. Accordingly, the solar electricity apparatus 110 is connected to the geothermal heat exchanger 55 of the geothermal heating apparatus and arranged to operate the geothermal heat exchanger 55. The solar electricity apparatus 110 is connected to the geothermal heat exchanger 55 with an electric connection 112 or electric cable 112. Accordingly, the solar electricity apparatus 110 is arranged to supply electricity to the geothermal heat exchanger 55 for operating the geothermal heat exchanger 55. The solar electricity apparatus 110 may also comprise the battery 111.

The solar electricity apparatus 110 may be connected to the geothermal heat exchanger 55 such that the geothermal heat exchanger 55 may utilize the electricity from the solar electricity apparatus to all operations and components of the geothermal heat exchanger 55. The solar electricity apparatus 110 may be connected to for example the first pump 8 or a control device (not shown) of the geothermal heat exchanger 55. The first pump 8 is arranged to circulate the geothermal working fluid in the geothermal heat exchanger 55. The control device may be any device arranged to control the operation of the geothermal heat exchanger 55. This concerns all the embodiment of the present invention in which the solar electricity apparatus 110 is connected to the heat pump 30.

According to the above mentioned, FIG. 4A shows an embodiment in which the electricity produced with the solar electricity apparatus 110 is utilized for operating the geothermal heat exchanger 55 in the charging mode. The thermal energy is thus transferred from the building 50 or the building space 51 via the heat pump 30 to the geothermal working fluid and further to the ground in the ground hole 2 as the geothermal heat exchanger 55 is operated in the charging mode and the heat pump 30 in the cooling mode. Therefore, the solar energy is stored to the ground with the solar electricity apparatus 110, heat pump 30 and the geothermal heat exchanger 55.

FIG. 4B shows another embodiment of the present invention in which the arrangement comprises the solar energy apparatus 110. The solar energy apparatus 110 is the solar electricity apparatus 110 arranged to produce electricity. The solar electricity apparatus 110 is provided in connection with or provided to the building 50 and connected to the geothermal heat exchanger 55 and to the heat pump 30 for supplying solar energy, produced solar electricity, to the geothermal heating apparatus, and especially to the geothermal heat exchanger 55 and the heat pump 30. Accordingly, the solar electricity apparatus 110 is connected to the geothermal heat exchanger 55 and the heat pump 30 of the geothermal heating apparatus and arranged to operate the geothermal heat exchanger 55 and the heat pump respectively. Accordingly, the FIG. 4B shows an embodiment which is combination of above described embodiments of FIGS. 3 and 4A.

According to the above mentioned, FIG. 4B shows an embodiment in which the electricity produced with the solar electricity apparatus 110 is utilized for operating the geothermal heat exchanger 55 in the charging mode and the heat pump 30 in the cooling mode.

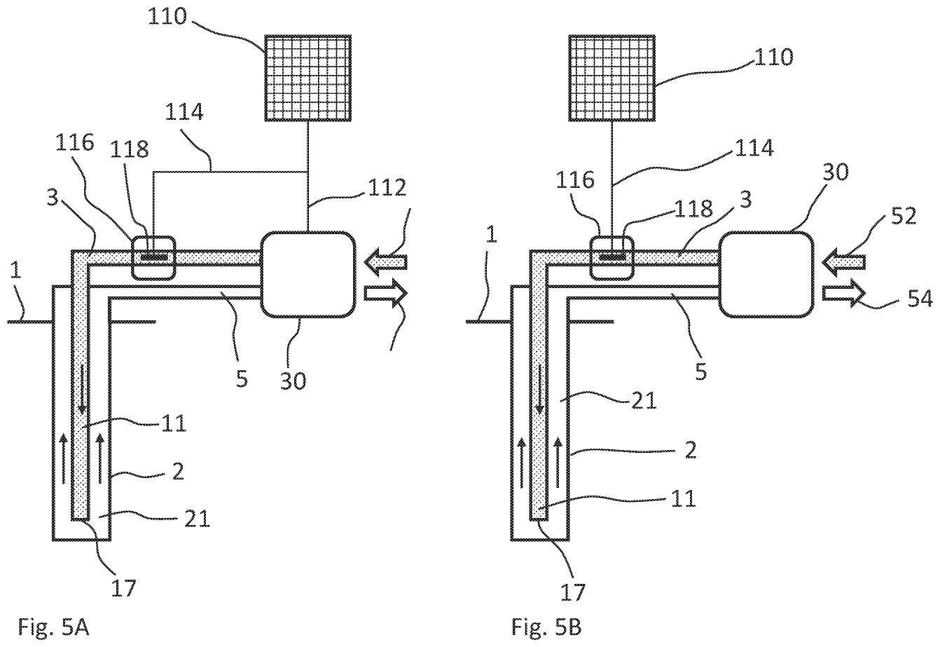

FIGS. 5A and 5B show alternative embodiments in which invention in which the arrangement comprises the solar energy apparatus 110. The solar energy apparatus 110 is the solar electricity apparatus 110 arranged to produce electricity. The solar electricity apparatus 110 is provided in connection with or provided to the building 50. The geothermal heating apparatus or the geothermal heat exchanger 55 further comprises an electrical heating device 116 having a heating element 118. The electrical heating device 116 may be any known kind of electrical heating device and the heating element 118 may be a heating resistor or the like. The solar electricity apparatus 110 is connected to the electrical heating device 116 with the electric connection 114 or electric cable 114. Accordingly, the solar electricity apparatus 110 is arranged to supply electricity to the electrical heating device 116 for operating the electrical heating device 116 and/or producing heat energy with the electrical heating device 116. The solar electricity apparatus 110 may also comprise the battery 111 for producing heat energy with the electrical heating device 116 when needed.

The electrical heating device 116 is arranged in connection with or provided to the geothermal heat exchanger 55 or the piping arrangement of the geothermal heat exchanger 55, or rise pipe 11 and/or the first connection pipe 3.

The electrical heating device 116 is preferably arranged to the rise pipe 10 or the first connection pipe 3 between the heat pump 30 and a lower end 17 of the ripe pipe 10 for heating the geothermal working fluid downstream of the heat pump 30 in the cooling and charging modes. Thus, the electrical heating device 116 may be arranged to heat the geothermal working fluid flowing or circulated from the heat pump 30 to the ground hole 2 for releasing thermal energy to the ground in the ground hole 2. Thus, the electrical heating device 116 and the solar electricity apparatus 110 together enable transferring solar energy to the geothermal working fluid and storing solar energy to the ground in the ground hole 2.

In the embodiment of FIG. 5A, the solar electricity apparatus 110 is connected to both the heat pump 30 and the electrical heating device 116, respectively, as disclosed above. Therefore, the solar electricity apparatus 110 is connected to the heat pump 30 with the electrical connection 112 for operating the heat pump 30 with the produced electricity. The solar electricity apparatus 110 is connected to the electrical heating device 116 with the electrical connection 114 for operating the electrical heating device and/or for producing thermal energy with the electrical heating device 116 utilizing the produced electricity.

In the embodiment of FIG. 5B, the solar electricity apparatus 110 is connected to only the electrical heating device 116, as disclosed above. Therefore, the solar electricity apparatus 110 is connected to the electrical heating device 116 with the electrical connection 114 for operating the electrical heating device and/or for producing thermal energy with the electrical heating device 116 utilizing the produced electricity.

According to the above mentioned, FIGS. 5A and 5B show embodiments in which the electricity produced with the solar electricity apparatus 110 is utilized for producing heat energy and charging the produced heat energy to the ground with the geothermal heat exchanger 55, when the geothermal heat exchanger 55 is operated in the charging mode and the heat pump 30 in the cooling mode.

In the context of the present application, the solar electricity apparatus is connected to a building electricity network 112, 114, 115. The building electricity network means the electricity network of the building which is separate from or connected to a nationwide or local area electricity network via building electricity junction. Accordingly, the electricity produced with the solar electricity apparatus provided to the building is supplied to the building electricity network or directly to the heat pump or the geothermal heat exchanger to be used for operating the geothermal heating apparatus and for charging thermal energy to the ground hole 2.

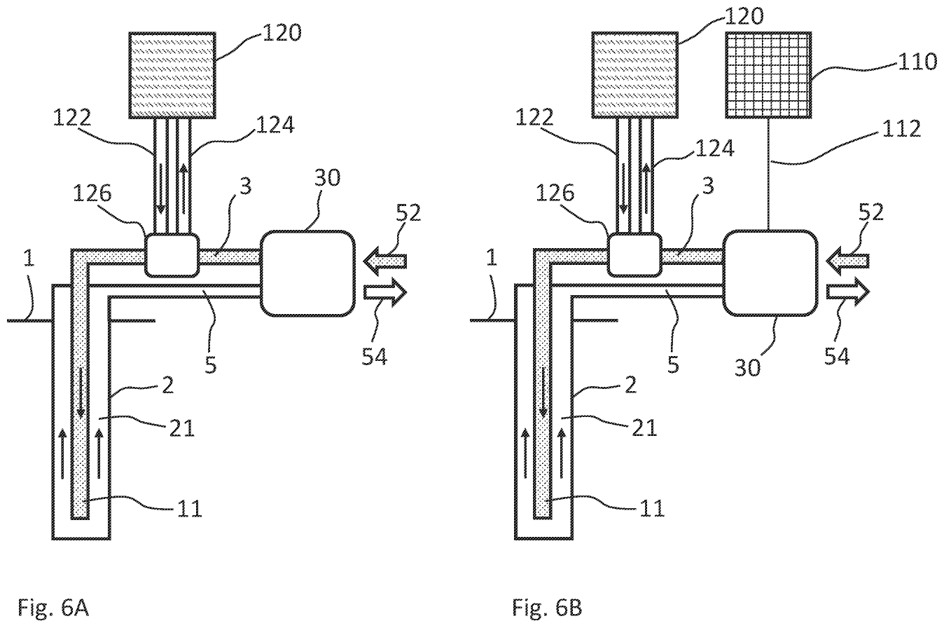

FIGS. 6A and 6B show one embodiment of the present invention in which the arrangement comprises a solar energy apparatus 120. The solar energy apparatus 120 is a solar heating apparatus 120 arranged to produce heat energy. The solar heating apparatus 120 is provided in connection with or provided to the building 50 and connected to the geothermal heat exchanger 55 for supplying heat energy, produced solar heat energy, to the geothermal heating apparatus, and especially to the geothermal heat exchanger 55. Accordingly, the solar heating apparatus 120 is connected to the geothermal heat exchanger 55 of the geothermal heating apparatus and arranged to transfer heat to the geothermal working fluid 55. The solar heating apparatus 120 is connected to the geothermal heat exchanger 55 with a solar heat exchange connection 126. Accordingly, the solar heating apparatus 120 is arranged to supply heat energy to the geothermal heat exchanger 55, and the geothermal working fluid.

The solar heating apparatus 120 may be solar heat collector in which solar working fluid is circulated. The solar heating apparatus 120 may have a collector element 120 and a solar heat exchanger 126 arranged in heat transfer connection with the geothermal heat exchanger 55. The solar heat exchanger 126 is arranged in connection with or provided to the geothermal heat exchanger 55 or the piping arrangement of the geothermal heat exchanger 55, or to the rise pipe 11 and/or the first connection pipe 3.

The solar heat exchanger 126 is preferably arranged to the rise pipe 10 or the first connection pipe 3 between the heat pump 30 and a lower end 17 of the ripe pipe 10 for heating the geothermal working fluid downstream of the heat pump 30 in the cooling and charging modes. Thus, the solar heat exchanger 126 may be arranged to heat the geothermal working fluid flowing or circulated from the heat pump 30 to the ground hole 2 for releasing thermal energy to the ground in the ground hole 2. Thus, the solar heat exchanger 126 and the solar heating apparatus 120 together enable transferring solar energy to the geothermal working fluid and storing solar energy to the ground in the ground hole 2.

The solar heat exchanger 16 may be any known kind of heat exchanger or heat exchange connection.

In the solar heating apparatus, the solar working fluid is heated in the solar collector element 120. The solar collector element 120 is arranged to transfer solar heat energy to the solar working fluid and to heat the solar working fluid. The solar heating device 120 may further comprise first collector pipe 122 provided between the collector element 120 and the solar heat exchanger 126 for circulating heated solar working fluid from the solar collector element 120 to the solar heat exchanger 126. In the solar heat exchanger 126 the solar working fluid releases thermal energy to the geothermal working fluid and the geothermal working fluid receives thermal energy from the solar working fluid. Thus, the temperature of the geothermal working fluid increases and the temperature of the solar working fluid decreases. The solar heating apparatus further comprises a second collector pipe 124 extending between the solar heat exchanger 126 and the solar collector element 120 for circulating the cooled solar working fluid from the solar heat exchanger 126 back to the solar collector element 120, as shown in FIG. 6A.

According to the above mentioned the solar heating apparatus 120 is connected to the geothermal heat exchanger with the solar heat exchange connection 126 such that the solar heat exchange connection 126 being arranged to transfer heat energy from the solar heating apparatus 120 to the geothermal heat exchanger, or from the solar working fluid of the solar heating apparatus 120 to the geothermal working fluid of the geothermal heat exchanger. The geothermal heat exchanger 55 or the geothermal working fluid thereof then transfers the heat energy further to the ground in the ground hole 2.

FIG. 6B shows an alternative embodiment, which is a combination of embodiment of FIGS. 3 and 6A. In this embodiment, the solar electricity apparatus 110 is connected to the heat pump 30 of the geothermal heating apparatus and arranged to operate the heat pump 30, as in the embodiment of FIG. 3. Accordingly, the solar electricity apparatus 110 is arranged to supply electricity to the heat pump 30 for operating the heat pump 30. Further, the embodiment comprises the solar heating apparatus 120 provided in connection with the geothermal heat exchanger 55 and arranged to transfer or release heat energy to the geothermal working fluid, as in the embodiment of FIG. 6A. Accordingly, in this embodiment both electricity and heat energy produced with the solar electricity apparatus and the solar heating apparatus are utilized for storing thermal energy to the ground with the geothermal heat exchanger.

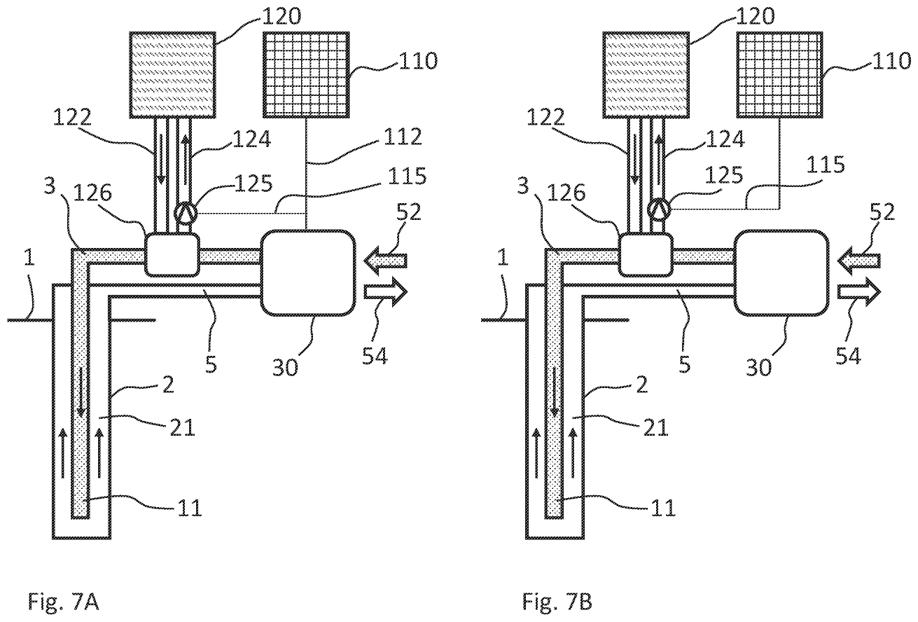

FIG. 7A show a further embodiments and modifications of the embodiment of FIG. 6B.

As shown in FIG. 7A, the solar heating apparatus 120 comprises a solar working fluid pump 125 arranged to circulate the solar working fluid. In the FIG. 7A, the solar working fluid pump 125 is provided to the second collector pipe 124. Alternatively, the solar working fluid pump 125 may be provided to the first collector pipe 122, the solar heat collector 120 or to the solar heat exchanger 126.

The solar electricity apparatus 110 may be connected to solar heating apparatus 120 for operating the solar heating apparatus 120. In FIGS. 7A and 7B, the solar electricity apparatus 110 is connected with the electric connection 115 to the solar heating apparatus 120. The solar electricity apparatus 110 is connected to the solar heating apparatus 120 and arranged to operate the solar working fluid pump 125 for circulating the solar working fluid. However, the solar electricity apparatus 110 may also be arranged to operate any other components of the solar heating apparatus 120, such as control device (not shown) of the solar heating apparatus. Accordingly, solar energy and solar electricity produced with the solar electricity apparatus 110 is used for operating the solar heating apparatus 120.

In the embodiment of FIG. 7A, the solar electricity apparatus 110 is connected only to the solar heating apparatus 120. In the embodiment of FIG. 7B, the solar electricity apparatus 110 is connected to the solar heating apparatus 120 and the heat pump 30 for operating both.

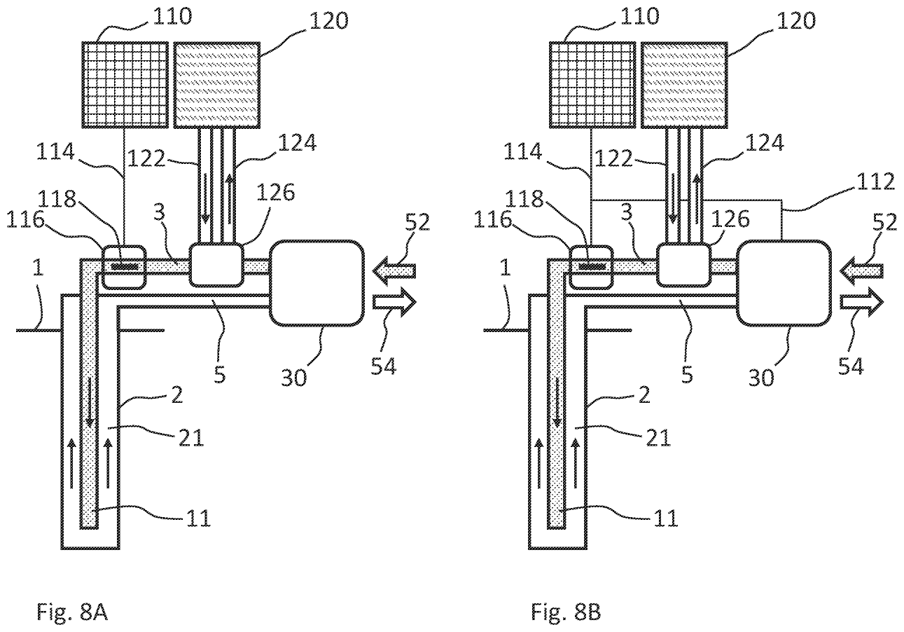

FIGS. 8A and 8B show further embodiment of the present invention.

Embodiment of FIG. 8A is combination FIGS. 5B and 6A. In this embodiment, the solar electricity apparatus 110 is connected to the electrical heating device 116 with the electrical connection 114 for operating the electrical heating device and/or for producing thermal energy with the electrical heating device 116 utilizing the produced electricity. Accordingly, the solar electricity apparatus 110 and the electrical heating device 116 are utilized for heating the geothermal working fluid and storing thermal energy to ground. Further in this embodiment, the solar heating apparatus 120 is provided in connection with or provided to the building 50 and connected to the geothermal heat exchanger 55 for supplying heat energy, produced solar heat energy, to the geothermal heating apparatus, and especially to the geothermal heat exchanger 55. Accordingly, the solar heating apparatus 120 is connected to the geothermal heat exchanger 55 of the geothermal heating apparatus and arranged to transfer heat to the geothermal working fluid 55. Accordingly, in this embodiment solar energy it used in two ways for heating the geothermal working fluid.

The embodiment of FIG. 8B corresponds the embodiment of FIG. 8A, but the solar electricity apparatus 110 is further connected to the heat pump 30 for operating the heat pump 30 as in the embodiment FIG. 3. However, the solar electricity apparatus 110 could additionally or instead be connected the solar heating apparatus 120 for operating the solar heating apparatus 120.

It should be noted, that in embodiment of FIGS. 6B, 7A, 7B, 8A and 8B in which the solar electricity apparatus 110 is utilized, the solar heating apparatus 120 or the collector element 120 thereof, may be replaced with a waste heat source 120. The waste heat source 120 may be provided with or connected to a waste heat exchanger 126 provided in connection with the geothermal heat exchanger and arranged to transfer heat energy from the waste heat source 120 to the geothermal heat exchanger 55 or from a waste heat fluid to the geothermal working fluid of the geothermal heat exchanger 55 or to the geothermal working fluid of the geothermal heat exchanger 55.

The waste heat source 120 is provided to or is in the building 50 and it may be ventilation or air-conditioning waste heat, waste heat from devices, such as computer servers or cooling or freezing devices, or the like.

FIG. 9 shows one embodiment of the geothermal heat exchanger 55. In this embodiment, a first thermal insulation 25 extends from the ground surface 1 to the lower end 17 of the rise pipe 11. Thus, the first thermal insulation 25 may extend along the entire length of the rise pipe 11, at least inside the ground hole 2 or the drain pipe 21. The first thermal insulation 25 may also extend along the entire length of the rise pipe 11. In this embodiment, the rise pipe 11 is arranged inside the drain pipe 21. The rise pipe 11 and the drain pipe 21 may be arranged coaxially and/or parallel to each other and within each other.

In this embodiment, the rise pipe 11 may be an evacuated tube comprising a vacuum layer surrounding the flow channel of the rise pipe 11. Thus, the vacuum layer is arranged to form the first thermal insulation 25. It may also be provided with any other insulating material.

The geothermal heat exchanger 55 of FIG. 9 comprises a first pump 8 arranged to the piping arrangement for circulating the geothermal working fluid in the piping arrangement in the charging mode in which the geothermal working fluid is circulated in the direction towards the lower end 17 of the rise pipe 11 or downwards in the rise pipe 11 and upwards the drain pipe 21, as shown with arrows 22 and 12. The first pump 8 may be any kind of known pump capable of circulating the geothermal working fluid. The geothermal heat exchanger 55 further comprises a second pump 9 arranged to circulate the geothermal working fluid in a direction downwards the drain pipe 21 and upwards the rise pipe 11, when the geothermal heat exchanger and the geothermal heat arrangement are in heat extraction mode. The second pump 9 may be any kind of known pump capable of circulating the geothermal working fluid. Accordingly, the first pump 8 is arranged to operate in the heat charging mode and the second pump 9 in the heat extraction mode. Thus, the first pump 8 is arranged to circulate the geothermal working fluid in a direction downwards rise pump 11 as heated geothermal working flow 22, and upwards the drain pipe 20 as cold geothermal flow as the geothermal working fluid releases thermal energy C from the heated geothermal working flow to the ground.

In FIG. 9, there is no separate drain pipe 21, but the ground hole 2 is arranged to form the drain pipe 21. This enables efficient heat transfer between the geothermal working fluid and the ground. In this embodiment, the ground may be formed from rock enabling using the ground as the drain pipe 21.

FIG. 10 shows another embodiment in which the rise pipe 11 is arranged inside the drain pipe 21. In this embodiment, the rise pipe 11 and the drain pipe 21 are arranged nested within each other or they may be arranged coaxially within each other such that the rise pipe 11 is inside the drain pipe 21, as in FIG. 9. The heated geothermal flow 22 flows downwards in the rise pipe 11 having the first thermal insulation 25 and flows out of the rise pipe 11 from the open lower end 17 of the rise pipe 11 into the drain pipe 21 surrounding the rise pipe 11. The geothermal working fluid releases thermal energy C to the ground at the lower end 13 of the drain pipe 21 or at the lower end 4 of the ground hole 2, and then flows as cold geothermal flow 12 upwards the drain pipe 21. The first thermal insulation 25 decreases or minimizes heat transfer between the rise pipe 11 and the drain pipe 21 and between the heated flow 22 and the cold flow 12.

As shown in FIG. 10, the thermal insulation 25 extends to a distance from the lower end 17 of the rise pipe 17.

In the embodiment of FIG. 10, the drain pipe 21 is pipe having a closed lower end 13 and extending inside the ground hole 2 to the lower end 4 of the ground hole in the vicinity thereof. Accordingly, the rise pipe 11 is entirely inside the drain pipe 21 in the ground hole 2 and the geothermal working fluid does not come in direct contact with the ground.

In this embodiment, there is only the first pump 8. The first pump 8 may a reversible pump arranged to pump the geothermal working fluid in a direction downwards the rise pipe 10 and upwards the drain pipe 20, or alternatively in direction downwards the drain pipe 20 and upwards the rise pipe 10. The first one is the charging mode in which thermal energy is charged to the ground and the second is a reverse mode, meaning extraction, mode in which charged thermal energy is extracted from the ground.

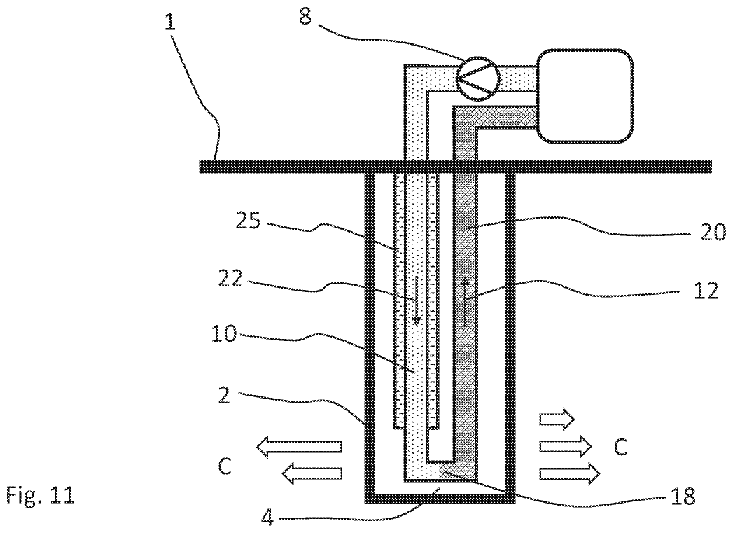

In the embodiment of FIG. 11, the rise pipe 10 and the drain pipe 20 are arranged at a distance from each other and connected to each other with a connection pipe part 18, or bend, at the lower ends of the rise pipe 10 and the drain pipe 20. In other words, the rise pipe 10 and the drain pipe 20 form a U-shaped pipe structure. However, it should be noted that the present invention is not limited to any particular pipe structure of the rise pipe 10 and the drain pipe 20 or any number of rise pipes 10 and drain pipe 20.

In the embodiment of FIG. 11, the first thermal insulation extends along the rise pipe 10 to distance from the lower end of the rise pipe 10 or the connection pipe part 18 or the bend.

In one embodiment, the rise pipe 3, 10, 11 of the piping arrangement 3, 5, 10, 11, 20, 21 of the geothermal heat exchanger 55 may comprises a an inner pipe wall, an outer pipe wall and an insulation material layer provided between the inner pipe wall and the outer pipe wall of the rise pipe 3, 10, 11. The insulation material layer may be arranged to form the first thermal insulation 25 surrounding the rise pipe 3, 10, 11 and extending along at least part of the length of the rise pipe 3, 10, 11.

The thermal insulation layer may be formed any suitable material preventing or decreasing heat exchange of the geothermal working fluid. The thermal insulation means material capable insulating against transmission of heat, or material of relatively low heat conductivity used to shield the fluid against loss or entrance of heat by radiation, convection, or conduction. Several different thermal insulation materials or vacuum may be used.

The thermal insulation 25 together with the heated geothermal flow 22 provided with the first pump 8 in the rise pipe 10 decreases or minimizes heat transfer from the heated primary flow 22 in the rise pipe 10 such that the geothermal working fluid may be transported in heated form or in elevated temperature to the lower end of the first pipe 10 and the lower end 4 of the ground hole 2. Accordingly, the geothermal working fluid releases thermal energy C at elevated temperature to the ground surrounding the ground hole 2 at the lower end of the ground hole 2 and thus charges thermal energy to the ground for later use. This applies to all embodiment in which the first thermal insulation 25 is used.

It should be noted, that also the drain pipe 20, 21 may be provided with a second thermal insulation extending from the ground surface towards the lower end 4 of the ground hole 2 in similar manner as the first thermal insulation.

According to the above mentioned, it should be noted that the present invention provides an arrangement which enables utilizing solar energy for storing thermal energy to ground with the geothermal heat exchanger. Accordingly, the first pump 8 is arranged to circulate the geothermal working fluid downwards along the rise pipe 10, 11, preferably insulated rise pipe, into the ground hole 2 having depth of at least 300 meters from the ground surface 1. In this depth, the temperature of the ground surrounding the ground hole 2 is high enough for preventing the heat energy from escaping away from the surroundings of the ground hole 2.

In preferred embodiments, the depth of the ground hole 2 is at least 600 meters, or at least 1000 meters or most preferably between 1500 and 3000 meters such that higher ground temperatures may be reached.

In a preferred embodiment of FIGS. 3, 4A and 4B, the solar energy is used directly for operating the heat pump 30 and/or the geothermal heat exchanger 55. Thus, the arrangement may be provided as energy self-sufficient as possible.

Furthermore, in the present invention the heat pump 30 and the solar energy apparatus 110, 120 are provided or installed to the building 50. Furthermore, the geothermal heat exchanger 55 is connected to the building 50 and the heat pump 30. Accordingly, this enables energy management of the building 50.

The present invention therefore provides a method for in connection with the building 50 for conditioning a building space 51 of the building 50. It should be noted that all the above mentioned in relation to FIGS. 1 to 11 apply directly as such also to the method of the present invention.

The method comprises operating the heat pump 30 in the cooling mode and the geothermal heat exchanger 55 in the heat charging mode, as described.

Accordingly, the method may comprise steps performing a first heat exchange step in which heat energy is extracted from a primary working fluid of the building space 50 to heat pump working fluid with a primary heat exchange connection 103 of a heat pump 30 for cooling the building space 50 and performing third heat exchange step in which heat energy is released from the heat pump working fluid with a secondary heat exchange connection 104 of the heat pump 30 to geothermal working fluid of a geothermal heat exchanger provided in a ground hole 2. This corresponds in operating the heat pump 30 in the cooling mode. The first heat exchange step may comprise both the first and the third heat exchange steps when the heat pump 30 utilizes a separate heat pump working fluid. The third heat exchange step is omitted when the primary working fluid, secondary working fluid or the geothermal working fluid is circulated in the heat pump 30. Further, the first heat exchange step may also comprise utilizing the secondary heat exchanger 31 and secondary working fluid. This, the heat energy is transferred from the primary working fluid via the heat pump 30 and the secondary working fluid to the geothermal working fluid in the first heat exchange step.

The method may further comprise performing a second heat exchange step in which heat energy is released from the geothermal working fluid of the geothermal heat exchanger to ground in the ground 2, or to ground at lower part of the ground hole 2, having depth at least 300 meters. This together with the first or first and second heat exchanger steps corresponds operating the geothermal heat exchanger 55 in the heat extraction mode.

The present invention also comprises producing solar energy with the solar energy apparatus 110, 120 provided to the building 50, and supplying the solar energy produced to the heat pump 30 or to the geothermal heat exchanger 55 or to the heat pump 30 and the geothermal heat exchanger 55.

The produced solar energy may be electricity. Thus, the method may comprise supplying the electricity produced with the solar electricity apparatus 110 to the heat pump 30 for operating the heat pump 30 in the cooling mode, and/or to the geothermal heat exchanger 55 for operating the geothermal heat exchanger 55 in the charging mode, and/or to the electrical heating device 116 provided in connection with the geothermal heat exchanger 55.

Alternatively or additionally, the produced solar energy may be heat energy. Thus, the method may comprise performing a fourth heat exchange step in which heat energy is released from the solar working fluid to the geothermal working fluid flowing from the heat pump 30 to the ground hole 2, or in which heat energy is released from the solar working fluid to the geothermal working fluid flowing from the heat pump 30 to the ground hole 2.

The method may also comprise comprises supplying electricity produced with the solar electricity apparatus 110 to the solar heating apparatus 120 for operating the solar heating apparatus 120.

The method may also comprise utilizing waste heat produced in the building 50 and performing a fifth heat transfer step in which waste heat energy produced in the building 50 is transferred to the geothermal working fluid flowing from the heat pump 30 to the ground hole 2, or to the geothermal working fluid flowing from the heat pump 30 to the ground hole 2.

Accordingly, the charging mode of the geothermal heat exchanger 55 Comprises circulating the geothermal working fluid in a downwards direction in the rise pipe 3, 10, 11 and in a direction upwards in the drain pipe 5, 20, 21 for transporting thermal energy towards the lower end 4 of the ground hole 2 such that the geothermal working fluid receives thermal energy from the heat pump working fluid in the second heat exchange step and in which the geothermal working fluid releases heat energy to the ground in the third heat exchange step. Further, the geothermal working fluid is circulated in the geothermal heat exchanger comprises circulating the geothermal working fluid in the geothermal heat exchanger 55 along the rise pipe 10, 11 having the first thermal insulation 25 along at least part of the length of the rise pipe 3, 10, 11.

The invention has been described above with reference to the examples shown in the figures. However, the invention is in no way restricted to the above examples but may vary within the scope of the claims.

1-15. (canceled)

16. A method in connection with a building for conditioning a building space of the building, the method comprises steps:
a) performing a first heat exchange step in which heat energy is extracted from a primary working fluid of the building space to a geothermal working fluid with a heat pump for cooling the building space and for heating the geothermal working fluid,
wherein the method further comprises steps:
b) circulating the heated geothermal working fluid in a geothermal heat exchanger into a ground hole in a rise pipe provided with a first thermal insulation along at least part of the length of the rise pipe;
c) performing a second heat exchange step in which heat energy is released from the heated geothermal working fluid in the geothermal heat exchanger to ground in the ground hole and the geothermal working fluid is cooled;
d) producing solar energy with a solar energy apparatus provided in connection with the building; and
e) supplying the solar energy produced in step d) to the heat pump or to the geothermal heat exchanger or to the heat pump and the geothermal heat exchanger.

17. The method according to claim 16, wherein the solar energy apparatus is a solar electricity apparatus and that:
the step d) comprises producing electricity with the solar electricity apparatus; and
the step e) comprises supplying the electricity produced with the solar electricity apparatus to a building electricity network of the building or directly to the heat pump or to the geothermal heat exchanger or to the heat pump and the geothermal heat exchanger.

18. The method according to claim 17, wherein the step e) comprises:
supplying the electricity produced with the solar electricity apparatus to the heat pump for operating the heat pump in a cooling mode in which the heat energy is extracted from the primary working fluid of the building space; or
supplying the electricity produced with the solar electricity apparatus to the heat pump for operating the heat pump in a cooling mode in which the heat energy is extracted from the primary working fluid of the building space to heat pump working fluid with a primary heat exchange connection of a heat pump and released from the heat pump working fluid with a secondary heat exchange connection of the heat pump; or
supplying the electricity produced with the solar electricity apparatus to the geothermal heat exchanger for operating the geothermal heat exchanger in a charging mode in which heat energy is released from the geothermal working fluid of the geothermal heat exchanger to ground in the ground hole; or
supplying the electricity produced with the solar electricity apparatus to a heating device provided in connection with the geothermal heat exchanger for operating the heating device and heating the geothermal working fluid flowing in the rise pipe to the ground hole with the heating device.

19. The method according to claim 16, wherein the solar energy apparatus is a solar heating apparatus and the step d) comprises heating a solar working fluid of the solar heating apparatus.

20. The method according to claim 19, wherein the step e) comprises:
performing a fourth heat exchange step in which the geothermal working fluid flowing in the rise pipe into the ground hole is heated with the solar working fluid of the solar heating apparatus; or
performing a fourth heat exchange step with a solar heat exchanger in which a solar heat exchanger is utilized for heating the geothermal working fluid flowing in the rise pipe into the ground hole with the solar working fluid of the solar heating apparatus; or
the solar energy apparatus comprises the solar electricity apparatus and the solar heating apparatus, and the step e) comprises supplying electricity produced with the solar electricity apparatus directly to the solar heating apparatus or to the building electricity network of the building for operating the solar heating apparatus.

21. The method according to claim 16, wherein the method further comprises step:
performing a fifth heat transfer step in which waste heat energy produced in the building is transferred to the geothermal working fluid flowing in the rise pipe into the ground hole; or
performing a fifth heat transfer step by utilizing a waste heat exchanger for transferring waste heat energy produced in the building to the geothermal working fluid flowing in the rise pipe into the ground hole.

22. The method according to claim 16, wherein performing the steps b) and c) comprises:
circulating the geothermal working fluid in the geothermal heat exchanger comprising a piping arrangement having the rise pipe arranged into the ground hole and a drain pipe arranged in the ground hole, the rise pipe and the drain pipe being arranged in fluid communication with each other for circulating the geothermal working fluid in the ground hole for performing the second heat exchange step, the ground hole extending from ground surface into the ground and having a lower end; and
operating the geothermal heat exchanger in a charging mode by circulating the geothermal working fluid in a direction downwards in the rise pipe and in a direction upwards in the drain pipe for transporting the heated geothermal working fluid towards the lower end of the ground hole in the rise pipe provided with the first thermal insulation such that the heated geothermal working fluid releases heat energy to the ground in the second heat exchange step; or
circulating the geothermal working fluid in the geothermal heat exchanger comprising a piping arrangement having the rise pipe arranged into the ground hole and a drain pipe arranged in the ground hole, the rise pipe being arranged inside the drain pipe and in fluid communication with the drain pipe for circulating the geothermal working fluid in the ground hole for performing the second heat exchange step, the ground hole extending from ground surface into the ground and having a lower end; and
operating the geothermal heat exchanger in a charging mode by circulating the geothermal working fluid in a direction downwards in the rise pipe and in a direction upwards in the drain pipe for transporting the heated geothermal working fluid towards the lower end of the ground hole in the rise pipe provided with the first thermal insulation such that the heated geothermal working fluid releases heat energy to the ground in the second heat exchange step.

23. An arrangement in connection with a building for conditioning a building space of the building, the arrangement comprising:
a ground hole provided into the ground and extending into the ground from ground surface and having a lower end;
a geothermal heating apparatus having a geothermal heat exchanger arranged in heat exchange connection with ground and a heat pump arranged in heat exchange connection with the geothermal heat exchanger and with a primary working fluid of the building space of the building,
the geothermal heat exchanger of the geothermal heating apparatus comprising a piping arrangement comprising a rise pipe having a lower end and arranged into the ground hole and a drain pipe having a lower end, the lower end of the rise pipe and the lower end of the drain pipe being arranged in fluid communication with each other for circulating the geothermal working fluid in the ground hole along the rise pipe and the drain pipe; and
a solar energy apparatus provided in connection with the building and connected to the geothermal heat exchanger or to the heat pump or to the geothermal heating exchanger and to the heat pump for supplying solar energy to the geothermal heating apparatus wherein:
the rise pipe of the piping arrangement of the geothermal heat exchanger is arranged inside the drain pipe and provided with a first thermal insulation surrounding the rise pipe and extending along at least part of the length of the rise pipe; and that
the geothermal heat exchanger of the geothermal heating apparatus further comprising a first pump connected to the piping arrangement and arranged to circulate the geothermal working fluid in the rise pipe and in the drain pipe, the first pump being arranged to circulate the geothermal working fluid in a direction towards the lower end of the ground hole in the rise pipe provided with the first thermal insulation and towards the ground surface in the drain pipe for supplying solar energy produced with the solar energy apparatus to the geothermal heating apparatus.

24. The arrangement according to claim 23, wherein:
the rise pipe of the piping arrangement of the geothermal heat exchanger is provided with the first thermal insulation surrounding the rise pipe and extending along at least part of the length of the rise pipe from the ground surface; or
the rise pipe of the piping arrangement of the geothermal heat exchanger is an evacuated tube comprising a vacuum layer surrounding a flow channel of the rise pipe, the vacuum layer arranged to form the first thermal insulation surrounding the rise pipe and extending along at least part of the length of the rise pipe; or
the rise pipe of the piping arrangement of the geothermal heat exchanger comprises an insulation material layer on an outer surface of the rise pipe, the insulation material layer arranged to form the first thermal insulation surrounding the rise pipe and extending along at least part of the length of the rise pipe; or
the rise pipe of the piping arrangement of the geothermal heat exchanger comprises an insulation material layer on an inner surface of the rise pipe, the insulation material layer arranged to form the first thermal insulation surrounding the rise pipe and extending along at least part of the length of the rise pipe; or
the rise pipe of the piping arrangement of the geothermal heat exchanger comprises an inner pipe wall, an outer pipe wall and an insulation material layer provided between the inner pipe wall and the outer pipe wall of the rise pipe, the insulation material layer arranged to form the first thermal insulation surrounding the rise pipe and extending along at least part of the length of the rise pipe.

25. The arrangement according to claim 23, wherein:
the ground hole forms at least part of the drain pipe; or
the ground hole forms at least part of the drain pipe and the rise pipe is arranged inside the ground hole and provided with an open lower end.

26. The arrangement according to claim 23, wherein the solar energy apparatus is a solar electricity apparatus and that:
the solar electricity apparatus is connected to a building electricity network of the building and the heat pump or the geothermal heat exchanger or the heat pump and the geothermal heat exchanger are connected to the building electricity network of the building; or
the solar electricity apparatus is connected directly or via a building electricity network of the building to the heat pump of the geothermal heating apparatus and arranged to operate the heat pump; or
the solar electricity apparatus is connected directly or via a building electricity network of the building to the geothermal heat exchanger of the geothermal heating apparatus and arranged to operate the geothermal heat exchanger; or
the solar electricity apparatus is connected directly or via a building electricity network of the building to the first pump of the geothermal heat exchanger of the geothermal heating apparatus and arranged to circulate the geothermal working fluid in a direction towards the lower end of the ground hole in the rise pipe and towards the ground surface in the drain pipe; or
the solar electricity apparatus is connected directly or via a building electricity network of the building to the electrical heating device provided in connection with the geothermal heat exchanger, the electrical heating device being arranged to heat the geothermal working fluid flowing in the rise pipe of the geothermal heat exchanger; or
the solar electricity apparatus is connected directly or via a building electricity network of the building to the electrical heating device provided to or in connection with the rise pipe of the geothermal heat exchanger, the electrical heating device being arranged to heat the geothermal working fluid in the rise pipe of the geothermal heat exchanger.

27. The arrangement according to claim 26, wherein:
the solar electricity apparatus is integral part of the building; or
the solar electricity apparatus is integral part of the building and connected to the building electricity network of the building; or
the solar electricity apparatus comprises one or more solar panels or solar cells arranged produce electricity and arranged to the structure of the building; or
the solar electricity apparatus comprises a solar roof, a solar window or a solar wall, the solar roof, the solar window or the solar wall forming at least part of the structure of the building and arranged to produce electricity.

28. The arrangement according to claim 23, wherein the solar energy apparatus is a solar heating apparatus arranged to heat a solar working fluid and that:
the solar heating apparatus is provided in connection with the geothermal heat exchanger and arranged to transfer heat energy from the solar heating apparatus to the geothermal heat exchanger or to the geothermal working fluid flowing in the rise pipe of the geothermal heat exchanger; or
the solar heating apparatus is connected to the geothermal heat exchanger with a solar heat exchange connection, the solar heat exchange connection being arranged to transfer heat energy from the solar heating apparatus to the geothermal heat exchanger or to the geothermal working fluid flowing in the rise pipe of the geothermal heat exchanger; or
the solar heating apparatus is connected to the geothermal heat exchanger with a solar heat exchange connection, the solar heat exchange connection being arranged to transfer heat energy from solar working fluid of the solar heating apparatus to the geothermal working fluid of the geothermal heat exchanger or to the geothermal working fluid flowing in the rise pipe of the geothermal heat exchanger.

29. The arrangement according to claim 23, wherein the building space conditioning arrangement comprise a waste heat exchanger connected to a waste heat source in the building and that:
the waste heat exchanger is provided in connection with the geothermal heat exchanger and arranged to transfer waste heat energy to the geothermal heat exchanger; or
the waste heat exchanger is provided in connection with the geothermal heat exchanger and arranged to transfer heat energy from waste heat fluid to the geothermal working fluid of the geothermal heat exchanger or to the geothermal working fluid flowing in the rise pipe of the geothermal heat exchanger; or
the waste heat exchanger is provided to or in connection with the rise pipe of the geothermal heat exchanger and arranged to transfer heat energy from waste heat fluid to the geothermal working fluid of the geothermal heat exchanger or to the geothermal working fluid flowing in the rise pipe of the geothermal heat exchanger.

30. The arrangement according to claim 26, wherein the building space conditioning arrangement comprises the solar electricity apparatus and the solar heating apparatus, and that:
the solar electricity apparatus is connected directly to the solar heating apparatus or to the building electricity network of the building and arranged to operate the solar heating apparatus; or
the solar electricity apparatus is connected directly to a second pump of the solar heating apparatus, the second pump being arranged to circulate solar working fluid.
